(19) United States
(12) Patent Application Publication
(10) Pub. No.: US 2007/0130340 A1
(43) Pub. Date: Jun. 7, 2007

(54) Cross-platform redirection of communications

(75) Inventors: Jordan Alperin, Denver, CO (US); Rich Cerami, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications International Inc., Denver, CO (US)

(21) Appl. No.: 11/292,801

(22) Filed: Dec. 2, 2005

(51) Int. Cl. G06F 15/173

(52) U.S. Cl. 709/226

(57) ABSTRACT

Systems, methods, and machine-readable media are disclosed to provide redirection of a communication across multiple platforms of potential diverse types. Cross-platform redirection of communications can comprise receiving a request to initiate a communication from an initiating end device. The request can identify an intended recipient device. A plurality of options for handling the communication by the recipient device can be determined. The options can be based on user profile information from a user of the recipient device, user profile information from a user of the initiating device, and/or a set of default options. A notification can be generated to inform the user of the recipient device of the communication. The notification can include an indication of the plurality of options for handling the communication. The notification can then be sent to the recipient device.

### CROSS REFERENCE TO RELATED APPLICATIONS

This application is related to co-pending U.S. patent application Ser. No. 11/255,089 entitled “Cross-Platform Support for a Variety of Media Types” filed Oct. 19, 2005 and co-pending U.S. patent application Ser. No. 11/266,011 entitled “Cross-Platform Message Notification” filed Nov. 2, 2005 both of which are herein incorporated by reference.

### BACKGROUND OF THE INVENTION

Embodiments of the present invention relate generally to communications networks and more particularly to providing for redirection of communications across various platforms or devices.

Today, it is very common, and probably the norm, for an individual to have and regularly use a number of communications devices of different types that communicate via a variety of different media. For example, an individual may, on a daily basis, use a number of different telephones such as a work line, a home line, one or more cell phones, etc. Additionally, this same individual may have and use a number of other communications devices and/or media such as one or more email accounts, one or more instant message accounts, etc. that are accessible through any of a number of different devices such as personal computers, various portable devices, and/or other network attached devices that communicate via the Internet or other network.

While the availability of these devices helps people stay in touch and communicate, it can present problems. For one, an individual using a number of communication devices may not be in constant or even regular use of one or more of these devices. For example, an individual may not carry his cell phone or Personal Digital Assistant (PDA) with him when he is in his office. Therefore, messages to these devices may go unnoticed by the user for an extended period of time. This leaves a caller or originator of the message to wait for the recipient of the message to notice and return the message. In other cases, an originator of a message may try other devices, such as the individuals work phone number, cell phone number, home number, different email or instant message addresses, etc. However, this leaves the originator with a number of different numbers and or addresses to try. This is burdensome and perhaps annoying to the originator. Further, the originator may know only one number or address associated with a particular individual and may be unaware of the individual's other numbers and/or addresses.

Furthermore, even if an individual becomes aware of the call or communication, he may not want to handle it at that time or through the communication media or device through which he became aware of the communication. That is, even if a communication network, such as a phone network, provides a way to simultaneously ring or otherwise notify multiple devices, such as multiple phones associated with one individual, that individual may not want to accept a phone call at that time, may want to take the call on a different network, or may want to communicate via a completely different media. For example, rather than accepting a telephone call, the individual receiving the call may want to initiate a video conference or transfer the call to a voice-to-text service for the caller to leave a voice mail message to be transcribed and emailed to the recipient. Currently, there is no way to redirect an incoming communication across various networks, media, or platforms in real-time. Rather, an individual receiving a communication is left with the options of accepting or not accepting the communication via the media and/or platform through which he is initially contacted. In the example presented above, a recipient of a phone call who would rather initiate a video conference is left with the option of accepting or answering the call, asking the originator to call back on video conferencing equipment, disconnect, and wait for the return call. This is time consuming and inconvenient. Hence, there is a need for methods and systems that allow for cross-platform message notification.

### BRIEF SUMMARY OF THE INVENTION

Systems, methods, and machine-readable media are disclosed to provide redirection of communications across multiple platforms of potentially diverse types. In one embodiment, a method of cross-platform redirection of communications can comprise receiving a request to initiate a communication from an initiating end device. The request can identify an intended recipient device. A plurality of options for handling the communication by the recipient device can be determined. The options can be based on user profile information from a user of the recipient device, user profile information from a user of the initiating device, and/or a set of default options. In some cases, the user profile information from the user of the recipient device can comprise one or more predetermined options defined by the user of the recipient device. The method can further comprise generating a notification to inform the user of the recipient device of the communication. The notification can include an indication of the plurality of options for handling the communication. The notification can then be sent to the recipient device.

According to another embodiment, the method can further comprise determining a plurality of possible recipient devices for the notification based on user profile information from the user of the recipient device. In such a case, sending the notification to the recipient device can further comprise sending the notification to each of the plurality of possible recipient devices.

According to yet another embodiment, determining a plurality of options for handling the communication by the recipient device can comprise determining at least one of the plurality options based information in the user profile database identifying types of devices available to the user of the recipient device. In other cases, determining a plurality of options for handling the communication by the recipient device can further comprise determining at least one of the plurality options based on information in the user profile database identifying types of devices available to a user of the initiating device.

According to still another embodiment, in response to the user of the recipient device selecting an option from the plurality of options to accept the communication, the initiating device can be connected with the recipient device. In other cases, in response to the user of the recipient device selecting an option from the plurality of options to redirect the communication, the initiating device can be connected with a device selected by the user of the recipient device. In still other cases, in response to the user of the recipient device selecting an option from the plurality of options to redirect the communication, a redirection notification to inform a user of the initiating device of the redirection can be generated and sent to the initiating device. The redirection notification can include an indication of options for redirecting the communication. In response to the user of the initiating device accepting the redirection, the initiating device can be connected with a device indicated in the redirection notification. In response to the user of the initiating device rejecting the redirection, the initiating device can be connected with the recipient device.

According to another embodiment, a system for providing cross-platform redirection of communications can comprise a communications bus and a user profile database communicatively coupled with the communications bus and adapted to maintain user profile information for a plurality of users. The system can also include a plurality of end devices of different types. Each end device can be communicatively coupled with the communications bus and adapted to send and receive common language messages via the communications bus, to translate common language messages received from the communications bus to a format specific to the end device based on the type, and to store user profile information in the user profile database. One or more managers can be communicatively coupled with the communications bus and adapted to receive via the communications bus a request to initiate a communication from an initiating device from the plurality of end devices. The request can identify an intended recipient device from the plurality of end devices. The manager can be further adapted to determine a plurality of options for handling the communication by the recipient device. The options can be based on user profile information from a user of the recipient device and/or user profile information from a user of the initiating device. The manager can generate a notification to inform the user of the recipient device of the communication. The notification can include an indication of the plurality of options for handling the communication. The manager can send the notification to the recipient device via the bus.

According to yet another embodiment, a machine-readable medium having stored thereon a series of instruction for which, when executed by a processor, cause the processor to perform cross-platform redirection of communications. Redirection can be performed by receiving a request to initiate a communication from an initiating device, the request identifying an intended recipient device. A plurality of options for handling the communication by the recipient device can be determined, the options based on user profile information from a user of the recipient device, user profile information from a user of the initiating device, and a set of default options. A notification to inform the user of the recipient device of the communication can be generated, the notification including an indication of the plurality of options for handling the communication. The notification can be sent to the recipient.

### BRIEF DESCRIPTION OF THE DRAWINGS

FIG. 1 is a block diagram illustrating, at a high-level, functional components of an architecture for providing cross-platform redirection of communications according to one embodiment of the present invention.

FIG. 2 is a block diagram illustrating functional component of an architecture for providing cross-platform redirection of communications according to an alternative embodiment of the present invention.

FIG. 3 is a block diagram illustrating an exemplary computer system in which embodiments of the present invention may be implemented.

FIG. 4 illustrates an exemplary user interface for informing a user of a communication and presenting options for handling the communication according to one embodiment of the present invention.

FIG. 5 illustrates an exemplary user interface for informing a user of a communication and presenting options for handling the communication according to an alternative embodiment of the present invention.

FIG. 6 is a flowchart illustrating a process for cross-platform redirection of communications according to one embodiment of the present invention.

FIG. 7 is a flowchart illustrating additional details of a process for cross-platform redirection of communications according to another embodiment of the present invention.

FIG. 8 is a flowchart illustrating details of a process for cross-platform redirection of communications according to yet another embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

Embodiments of the present invention provide methods, system and machine-readable media for providing redirection of a communication across multiple platforms of potentially diverse types. As will be described in detail below, cross-platform redirection of communications can comprise receiving a request to initiate a communication from an initiating end device. The request can identify an intended recipient device. A plurality of options for handling the communication by the recipient device can be determined. The options can be based on user profile information from a user of the recipient device, user profile information from a user of the initiating device, and/or a set of default options. In some cases, the user profile information from the user of the recipient device can comprise one or more predetermined options defined by the user of the recipient device. According to one embodiment, determining a plurality of options for handling the communication by the recipient device can comprise determining at least one of the plurality options based information in the user profile database identifying types of devices available to the user of the recipient device and/or information in the user profile database identifying types of devices available to a user of the initiating device.

Redirection can further comprise generating a notification to inform the user of the recipient device of the communication. The notification can include an indication of the plurality of options for handling the communication. The notification can then be sent to the recipient device.

According to one embodiment of the present invention, in response to the user of the recipient device selecting an option from the plurality of options to accept the communication, the initiating device can be connected with the recipient device. In other cases, in response to the user of the recipient device selecting an option from the plurality of options to redirect the communication, the initiating device can be connected with a device selected by the user of the recipient device. In still other cases, in response to the user of the recipient device selecting an option from the plurality of options to redirect the communication, a redirection notification to inform a user of the initiating device of the redirection can be generated and sent to the initiating device. The redirection notification can include an indication of options for redirecting the communication. In response to the user of the initiating device accepting the redirection, the initiating device can be connected with a device indicated in the redirection notification. In response to the user of the initiating device rejecting the redirection, the initiating device can be connected with the recipient device.

So, in effect, the user of the initiating end device, such as a cell phone, can initiate a communication, such as placing a phone call, with the user of a recipient device, such as another cell phone or other telephone. As a result of the initiation of this communication, a number of other devices associated with the recipient can be made to inform the recipient of the communication. That is, the recipient's Personal Digital Assistant (PDA), Personal Computer (PC), and/or other telephones can ring or otherwise inform the user of the communication. According to one embodiment of the present invention, multiple devices associated with the recipient or the recipient device can be made to ring or give notification of an incoming communication can be performed in accordance with methods and systems described in the above referenced, co-pending U.S. Patent Application entitled “Cross Platform Message Notification.”

Furthermore, as will be seen, this notification can include a number of options for handling the communication. For example, the options may include ignoring the communication, accepting the communication, redirecting the communication to another device or devices, etc.. The options presented in the message notification can be based on, among other possibilities, user preference information for the originator of the communication, the recipient of the communication, or some combination thereof. For example, the preference information may indicate what type of devices the originator and/or the recipient have available and therefore, the other devices to which the communication can be directed. In response to the recipient selecting one of the options, the communication can be handled accordingly. For example, the communication can be disconnected, accepted, or redirected to another device identified in the list of options depending upon the option selected.

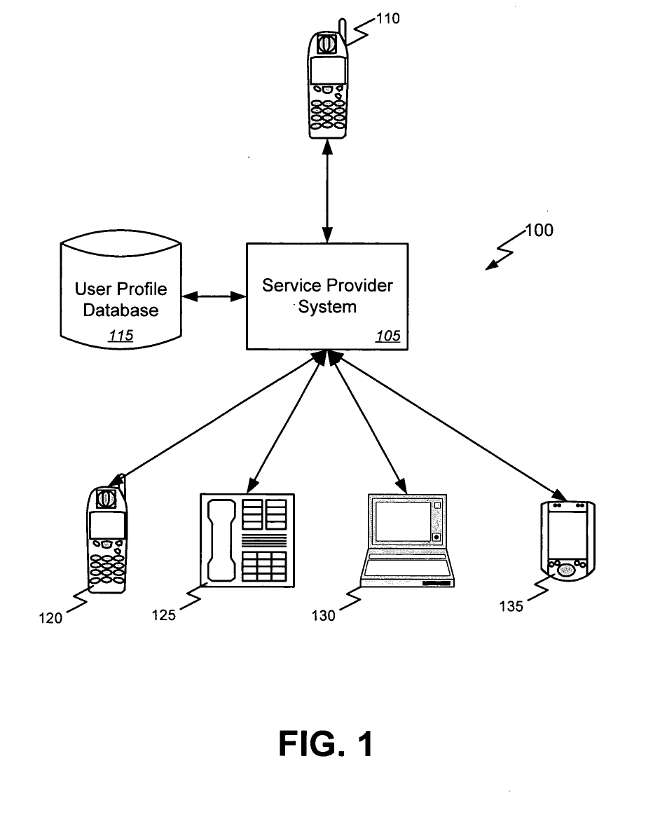

FIG. 1 is a block diagram illustrating, at a high-level, functional components of an architecture for providing cross-platform redirection of communications according to one embodiment of the present invention. In this example, the system 100 includes an initiating device 110 communicatively coupled with a service provider system 105. The service provider system 105 can be communicatively coupled with a user profile database 115 and a plurality of recipient devices 120-135. Generally speaking, and as will be described in greater detail below, the initiating device 110 can initiate a communication such as a telephone call to one of the recipient devices 120-135 through the service provider system 105. Based on information stored in the user profile database 115 and as described, for example, in the co-pending U.S. patent application entitled “Cross-Platform Message Notification” referenced above, the service provider system 105 can notify one or more of the recipient devices 120-135 of the communication. Furthermore, the notification can include a number of options for handling the communication based on information stored in the user profile database 115 by the user of the initiating device 110, the user of the recipient device 120-135, and/or by default. Details of the information of the user profile database 115 will be discussed further below. Generally speaking the user profile database 115 can include default or standard options for handling communications and/or specific options for how the recipient and/or originator may be able to or wish to handle communications.

Initiating device 110 can be any of a number of possible communication devices. While illustrated here as resembling a cell phone, initiating device can also be a land line telephone, a Personal Digital Assistant (PDA), any of a variety of wireless devices, a personal computer, etc. Regardless of the exact type of device, initiating device 110 can be communicatively coupled with service provider system 105 via typical communication media such as a cellular network, a land line telephone, a Local Area Network (LAN), Wide Area Network (WAN), the Internet, or other type of network. Through this communication media, initiating device 110 can send and receive communications to and from the service provider system 105.

Service provider system 105 can be one or more systems adapted to provide communications services of one or more types to the initiating device 110. For example, service provider system 105 can be a system providing cellular telephone services, land line telephone services, Internet services, etc. Service provider system 105 can be adapted to send and receive communications of an appropriate type to and from initiating device 110.

User profile database 115 can be communicatively coupled with service provider system 105 via a Local Area Network (LAN), Wide Area Network (WAN), the Internet, or other type of network or other communications media. While user profile database 115 is shown in this example as being separate from the service provider system 105, the user profile database may be internal or external to the service provider system 105 or may be part of and/or maintained by another system and may be either local to or remote from the service provider system 105. Regardless of the exact configuration, user profile database 115 maintains a set of user profile data or preferences for one or more users of the service provider system 105 such as a user of initiating device 110 and/or users of recipient devices 120-135. For example, the user profile database 115 may include information relating to call features such as call forwarding or other information relating to other types of communications such as email delivery options. Additionally or alternatively, user profile database 115 may include information related to the types and numbers of devices used by the user and/or options for handling communications. Additionally or alternatively, some or all such information may also be stored in the initiating end device and accessed at the time the communication is initiated. As will be seen, such information can be used as or to generate options for handling or redirecting communications.

According to one embodiment of the present invention, as described in the co-pending U.S. patent application entitled “Cross-Platform Message Notification” referenced above, user profile database 115 can also store information related to message notification features. More specifically, user profile database 115 can include a list of phone numbers, device addresses, or other identifying information for one or more recipient devices that a user of an initiating device may wish to contact. In other words, the user profile database 115 can include an identifier, such as a phone number, email address, Internet Protocol (IP) address, instant message address, physical address, MAC address, etc for each of the plurality of possible recipient devices. When the user of the initiating device 110 initiates a communication to one of these devices, the service provider system 105 can look up other related devices and generate a message, communication, notification, etc. appropriate to each of those devices to inform the recipient of the requested communication. In this way, all, or some subset of all, of the identified devices can “ring” or otherwise inform the user of a message or call.

User profile database 115 can also include, for example, a list of devices the recipient and/or the originator have available. In some cases, the user profile database 115 can additionally or alternatively include a list of standard options for handling and/or redirecting communications. For example, some standard or default options may include options to answer or receive the call or communications, ignore or disconnect the communications, send the originator a standard or other predetermined message, etc. Additionally or alternatively, the service provider system 105 can generate a number of other options for handling and/or redirecting the communication. For example, if the user profile database 115 indicates that both the originator and the recipient have video conferencing equipment available, the service provider system can generate an option to initiate a video conference and add the option to the list of standard and/or other options to be provided to the recipient. Additional details of a method for generating and or sending such options will be discussed below.

Recipient devices 120-135 can be any of a number of possible communication devices. For example, recipient devices can be cell phones, land line telephones, Personal Digital Assistants (PDAs), any of a variety of wireless devices, Personal Computers (PCs), etc. Regardless of the exact types of devices, recipient devices 120-135 can be communicatively coupled with service provider system 105 via typical communication media such as a cellular network, a land line telephone, a Local Area Network (LAN), Wide Area Network (WAN), the Internet, and/or other types of networks. Through this communication media recipient devices 120-135 can send and receive communications to and from the service provider system 105.

Importantly, while referred to herein as a recipient device or an initiating device for the sake of explanation, any device coupled with the service provider system 105 can potentially, at various times, act as either an initiating device or a recipient device. For example, a particular cell phone may at one point initiate a call but at another time may receive a call. Therefore, the labels of initiating device and recipient device are illustrative only and indicate only a particular device's function at a specific point in time rather than indicating any limits on its functionality overall.

In use, initiating device 110 can initiate a communication, such as a phone call, email, instant message, etc. According to one embodiment of the present invention, this can be accomplished by the initiating device 110 sending a request to the service provider system 105. The request can identify a single intended recipient device. That is, the initiating device 110 can place a call to a particular phone number or send a message to a particular email or Internet Protocol (IP) address or otherwise direct a communication to a particular recipient device.

The service provider system 105 can then receive the request to initiate a communication from the initiating end device 110 and determine one or more possible recipient devices for the request. This determination can be based on the user profile information in the user profile database previously provided by the user of the initiating end device or the user of the intended recipient device, i.e., the device called or otherwise addressed by the initiating device 110. In other words, when the user of initiating device 110 has decided to call his friend Chuck and places a call to a particular number associated with Chuck, such as his cell phone number, the service provider system 105 can receive this request or call, lookup other information, i.e., numbers or addresses, related to Chuck stored in the user profile database 115, and use these numbers and/or addresses and information identifying the type of device at that number or address to generate a message of communication appropriate to that device and forward the call to all, or some subset of all, of Chuck's devices. The service provider system 105 can also determine a number of options for handling and/or redirecting the communication based on information from the user profile database 115 including, but not limited to, a number of standard options, devices and/or preferences for the originator, devices and/or preferences for the recipient, etc. Therefore, the notification sent can also include a number of options to be presented to the recipient with notification of the communication.

The service provider system 105 can then forward the notification to each of the one or more possible recipient devices to inform the recipient of the communication and present the options for handling the communication. In response to the recipient selection one of the options, the communication can be handled appropriately. That is, the service provider system can connect the initiating device 110 to a recipient devices, redirect the communication to another device, or provide some other handling of the communication based on which option the recipient selects via one of the potential recipient devices.

Therefore, the user of the initiating device can call or send a message to a number or address related to a recipient device. The service provider system can then generate one or more notifications appropriate for the recipient device(s) associated with the original number or address and forward the notification(s) to the recipient device(s) to inform the recipient of an incoming communication and provide options for handling the communication. So, a call, e.g., to Chuck's cell phone, can cause a notification to be forwarded to one or more other devices, e.g., Chuck, home phone, work phone, PDA, personal computer, pager, etc, as well as the originally called number. If Chuck selects one of the options presented in the notification, e.g, answering the call, transferring the call to voicemail, requesting a video conference, etc., the communication can be handled appropriately. That is, the service provider system 105 can connect, transfer, disconnect, or switch the communication as indicated by Chuck's selection of one of the options presented by the notification.

Alternatively, another architecture that provides support for communications between a number of different devices of different types may be used to provide the same functions. Such an architecture is described in the above referenced, co-pending U.S. patent application titled “Cross Platform Support for a Variety of Media Types.” While not necessary to implement various embodiments of the present invention, such an architecture is considered useful with embodiments of the present invention since it provides a communication bus that in turn provides a common representation, in the form of a number of common language messages, of services or information available to, from, and between end devices regardless of the type of end device or the server providing or receiving the information or service. For example, one of these common language messages can be used to provide notification of communications and options for handling the communication. Furthermore, the architecture includes a central user profile database that can be used to store information related to communication redirection features such as discussed above. An overview of this architecture is now provided for convenience.

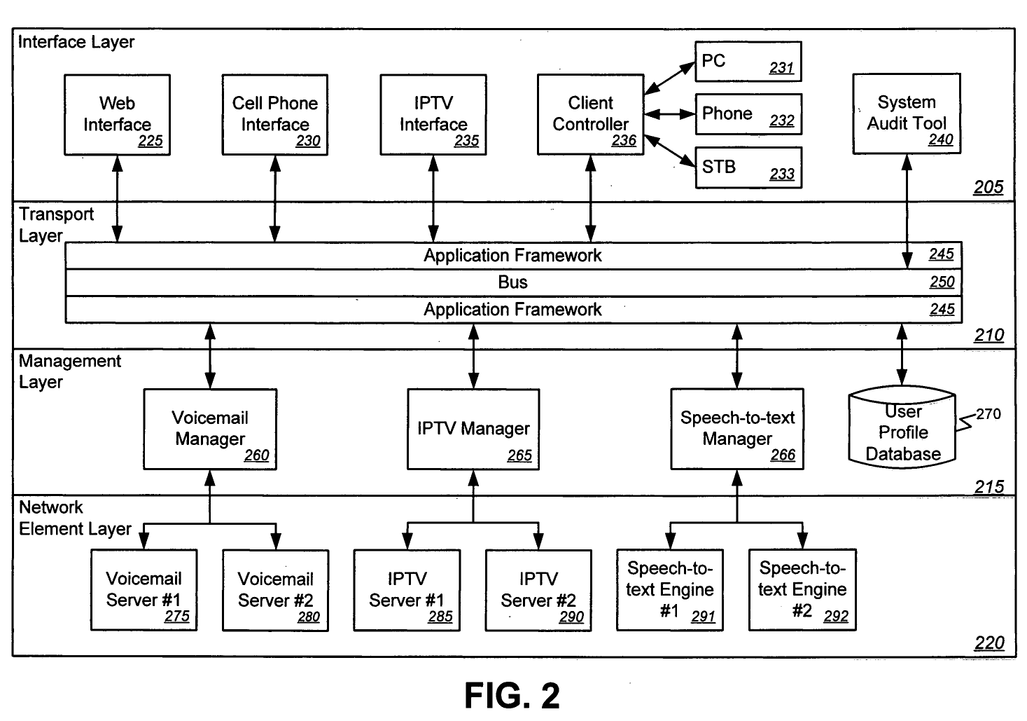

FIG. 2 is a block diagram illustrating functional component of an architecture for providing cross-platform redirection of communications according to an alternative embodiment of the present invention. In this example, the architecture is logically divided into four layers 205-220. The layers 205-220 include a network element layer 220, a management layer 215, a transport layer 210, and an interface layer 205. As will be seen, elements of each layer 205-220 can be communicatively coupled with elements of the next layer 205-220. So, elements of the network element layer 220 can be communicatively coupled with elements of the management layer 215 which in turn can be communicatively coupled with elements of the transport layer 210, etc.

The network element layer 220 can comprise one or more servers 275-292. The servers 275-292 of the network element layer 220 can each provide content and/or services of one or more types. For example, one or more servers 275 and 280 may provide voicemail services while one or more other servers 285 and 290 provide television (TV) content services, while yet other servers 291 and 292 provide speech-to-text services, etc.. Importantly, while this example shows a limited number of servers 275-292 in the network element layer 220, many more servers, providing a wide range of content or services of various types may be included. For example, one or more servers may be included for providing Internet services, Email services, and various other types of data, communication, and/or entertainment services.

The management layer 215 can comprise one or more managers 260-266. Each manager 260-266 can be communicatively coupled with one or more of the servers 275-292 of the network element layer 220. For example, voicemail manager can be coupled with voicemail servers 275 and 280 while TV content manager 265 can be coupled with TV content servers 285 and 290. Importantly, while managers 260-266 and servers 275-292 are shown and described herein as being organized by or arranged per service, other arrangements are contemplated and considered to be within the scope of the present invention. According to one alternative, the managers 260-266 and the servers 275-292 may be arranged by company or provider. So, for example, one manager may be coupled with and provide access to the services and content provided by the servers of company A while another manager may be coupled with and provide access to the services and content provided by the servers of company B. However, an arrangement of managers 260-266 and servers 275-292 based on service and/or content type may be preferable since, as will be seen, such an arrangement can provide for easier extensibility of the system when adding features or services.

Furthermore, as noted above, additional servers may be used in the network element layer providing additional services and/or content of different types. Therefore, more, fewer, or different managers than shown in this example may be used in an actual implementation. For example an additional manager may be used for interfacing with one or more servers providing Internet services or email services. In another example, one or more managers may be communicatively coupled with one or more servers tracking billable events on the architecture. That is, one manager may track calls, messages, events, or pay-per-view or other content billed on a per-use basis so that the appropriate users can be billed by the operator of the architecture, the provider of the content, and/or other parties.

Regardless of the exact number, nature, or organization of the servers 275-292 and managers 260-266, the managers 260-266 can be adapted to translate content of the servers 275-292 with which the manager 260-266 is connected from the media types of the servers 275-292 to one or more common language messages. That is, the managers 260-266 can provide translation from a service specific format to a common or generic format. For example, voicemail server #1 275 and voicemail server #2 280 may be operated by different entities and offer different information in different formats that may be completely incompatible with each other. However, voicemail manager 260 provides for translating these different functions, formats, etc into a common language message that can be used by all other elements of the architecture.

According to one embodiment of the present invention, the managers 260-266 can provide defined interfaces to the servers 275-292 of the network element layer 220. By using calls, invocations, requests, or other signals or messages to the managers 260-266, the servers 275-292 can pass content or messages to the managers 260-266 for translation to a common language message for transmission to another element of the architecture. For example, voicemail manager 260 may provide an Application Program Interface (API) for use by any voicemail server 275 and 280 connected with the voicemail manager 260. Voicemail servers 275 and 280 can then use API calls to the voicemail manager 260 to initiate services, pass content or other information, and/or otherwise communicate with the voicemail server 260. According to one embodiment of the present invention, calls to the API or other interface may be closely analogous to the common language messages generated by the manager. For example, as will be described in detail below, the manager may generate an “InitiateCommunication” message to initiate a communication. The manager's API may also provide a “InitiateCommunication” or other similar call to the servers to which it is connected through which the servers can initiate a communication.

While use of an API or other defined interface between the managers 260-266 and the servers 275-292 is not required, it may be preferred since, by using an API or other type of defined interface, the managers 260-266 can be easily extended or modified as services and/or content of the servers are added or changed or as new servers are added. That is, the use of a defined interface such as an API allows greater extensibility since the only changes made at the manager would be to add or modify an appropriate “stub,” module, or routine to add a new server, service, or content type without a need to make wholesale changes or re-write the managers.

According to one embodiment of the present invention, the manager and the API or interface of the manager may be implemented using object-oriented programming techniques. In such a case, the manager API calls made by the servers can cause the stub or module of the manager interfacing with the server to instantiate an object of a particular class type, such as a “InitiateCommunication” object, with properties representing, among other possibilities, the content of data to be communicated, the intended recipient(s), etc. Such an object or common language message may be defined in a common format readable by other elements of the architecture. For example, the object may be defined in an eXtensible Markup Language (XML) file. The manager can then transmit this object or common language message to any or all of the other elements of the architecture via the transport layer 210.

The transport layer 210 can comprise a communications bus 250 communicatively coupled with each of the managers 260-266. The bus 250 can be adapted to receive and transport the one or more common language messages from the managers 260-266. The transport layer 210 can also comprise an optional application framework 245 interposed between the end devices 225-236 of the interface layer 205 and the communications bus 250 and between the managers 260-266 and the communications bus 250. Generally speaking, the application framework 245 provides for monitoring and tracking of the common language messages placed on the bus 250 of the transport layer 210.

Regardless of whether the application framework 245 is used, the bus 250 of the transport layer 210 comprises a common representation of data that is usable by all elements of the architecture. Furthermore, the bus 250 provides this message to any or all devices in the architecture as appropriate regardless of the type of device.

According to one embodiment of the present invention, the bus 250 may also be implemented using object-oriented programming techniques. In such a case, a manager placing or sending a common language message on the bus 250 can call or invoke an API or other interface of the bus 250 or otherwise cause the instantiation of an object of a particular class type, such as a “InitiateCommunication” object, with properties representing, among other possibilities, the content of data to be communicated, the intended recipient(s), etc. The bus can then make this object or common language message available to any or all of the other elements of the architecture.

The interface layer 205 of the architecture can comprise one or more end devices 225-236 of different types. For example, the end devices 225-236 can represent a cell phone 230, a web browser 225, a TV interface 235, etc all potentially operating on different platforms with different operating systems. Each end device 225-236 can be communicatively coupled with the bus 250 of the transport layer, either directly or via the application framework 245, and can be adapted to receive and translate the common language messages to a format specific to the end device based on its type.

Alternatively or additionally, one or more of the end devices may comprise a client controller 236 communicatively coupled with the bus 250 of the transport layer 210 and one or more other end devices 231-233 such as a personal computer 231, television Set-Top Box (STB) 233 for television service, telephone 232, or other type of device. If used, the client controller 236 can be adapted to receive common language messages from the bus 250, translate content from the common language messages to a format specific to the end device(s) 231-233 for which it is intended, and deliver the device specific message to the device or devices. In some cases, the client controller 236 may also be adapted to act as a firewall for end devices 231-233 communicating via the bus 250 of the transport layer 210.

Therefore, the end devices 225-236 can translate from the common language messages, such as an XML message, to device specific representations of the information in that message for presentation to user in whatever format that device uses. According to one embodiment, the translation functions of the end devices can also be implemented using object-oriented programming techniques. In such a case, the end devices receive the common language messages such as XML encoded representations of the objects on the bus 250 of the transport layer 210. Translation can therefore comprise instantiating on the end device an object of the class indicated by the message with the properties indicated by the message thereby translating the properties of the object on the bus to a presentation language of the device.

Thus far, the description of the architecture has focused on messages from the servers 275-292 to the end devices 225-236. However, the end devices 225-236 can also be adapted to generate one or more common language messages based on user input and send the one or more common language messages to one or more of the managers 260-265 via the bus 250. For example, a cell phone 230 or other end device 225-236 can generate a “InitiateCommunication” message to be sent to any or all of the managers 260-265 or even to another end device. Therefore, the managers 260-265 can be further adapted to receive the common language messages from the end devices 225-236 via the bus 250 and to translate the common language messages to content of the media type of the servers 275-292 with which the manager 260-266 is connected.

According to one embodiment of the present invention, the architecture can include a user profile database 270 communicatively coupled with the bus 250 of the transport layer. The user profile database 270 can be adapted to maintain records of a set of user preferences for one or more of the end devices 225-236 of the interface layer 205. For example, TV or cell phone settings or options for a particular device and/or a particular user can be stored in the user profile database 270 for retrieval by one or more of the end devices 225-236 or one or more of the managers 260-266. Therefore, the user profile database 270 can be adapted to provide the preferences to one or more of the end devices 225-236 or one or more of the managers 260-266 in response to a common language message received via the bus 250. In another example, the user profile database 270 can be adapted to store information related to options for handling and/or redirecting communications. More specifically, user profile database 270 can include a list of standard or default options for handling a communication such as, for example, ignore or disconnect, accept, etc. Additionally or alternatively, the user profile database 270 can include a list of custom and/or user defined options such as one or more predefined recordings or stored voice, text, or other format responses or messages. In other cases, information can additionally or alternatively be stored in the user profile database 260 that can be used by one or more managers to generate options. For example, the user profile database 270 can include information identifying devices and/or types of devices available to the originator and or recipient. Additionally or alternatively, some or all information for redirecting communications can be stored on the initiating end device and/or the recipient end device(s). Such information, if available, can be used to generate options for redirecting communications. For example, if both parties have video conferencing equipment available, an option to initiate a video conference may be included in the message notification sent to the recipient.

Therefore, in use, the bus 250 provides a common representation of services or information available to, from, and between the end devices 225-236 regardless of the type of end device or the server providing or receiving the information or service. This common representation is in the form of a number of common language messages. The type, number, format, etc. of the common language messages can vary widely depending upon the exact implementation without departing from the scope of the present invention. However, for illustrative purposes only, some exemplary messages will be described.

According to one embodiment, the common language messages can include a “InitiateCommunication” request message indicating a request to initiate a communication. Similarly, the common language messages can include a “InitiateCommunication” response message acknowledging initiation of a communication. As will be discussed in greater detail below, “InitiateCommunication” request and response messages can be used to provide notification of a communication and options for handling the communication as well as responding with a selection or request to redirect the communication. Alternatively or additionally, a separate communication notification message can be used to provide notification of a communication and options for handling the communication as well as responding with a selection or request to redirect the communication. According to another embodiment, the common language messages can include a “Communication Information” request indicating a request for information relating to a communication and a “Communication Information” response providing requested information. The common language messages can also include a “Communication Event Notification” message indicating the occurrence of a communication.

In some cases, the common language messages can include an “Update Profile” message indicating a change to one or more user defined preferences. As indicated above, such a message can be useful in updating one or more entries in the user profile database 170. Furthermore, such a message may be useful in informing other devices of a change.

According to one embodiment of the present invention, the common language messages can also include a periodic “Heartbeat” message indicating a normal status of an end device, manager, and/or server. Since the architecture is loosely coupled, i.e., any given device or service is not directly coupled with any other, elements of the architecture may not be aware of the availability of another. So, each element of device can periodically send a heartbeat message. As will be discussed below, this message may be monitored by the system audit tool for maintenance and/or troubleshooting purposes.

The various types of message can take any of a variety of possible formats without departing from the scope of the present invention. However, for illustrative purposes only, an exemplary format for a message may be considered to include a header and a body. The header may include information such as any or all of: an address or other indication of the device or devices for which the message is intended; an address or other indication of the device originating the message; an indication of the message type; an indications of the type of contents in the message; etc. The message body may include information such as representation of or actual content to be transferred. Therefore, the body can contain an email message, an audio or video file, a hyperlink or other direction to a location of the actual content, etc. However, once again, the exact format of the common language messages can vary widely depending on the exact implementation.

Regardless of the exact format, translating content to a common language message or generating a common language message can comprise generating a file, such as an XML file, of the appropriate format to indicate the type of message and the end devices for which it is intended and possibly an indication of the contents. Alternatively, as indicated above, various components of the architecture may be implemented using object-oriented programming techniques. In such a case, generating a common language message can comprise instantiating an object of a particular class type, such as a “InitiateCommunication” object, with properties representing, among other possibilities, the content of data to be communicated, the intended recipient(s), etc.

According to one embodiment, the common language messages can include a “InitiateCommunication” request message indicating a request to initiate a communication. Such a message can be initiated by one of the end devices 225-240 and sent via the bus 250 of the transport layer 210 to a manager 260 or 265 coupled with a server 275-292 providing a service to that end device. Upon receiving the message, the server or manager can, in some cases, look up other devices related to the called device in the user profile database 270. The server can then generate “InitiateCommunication” request messages to the other devices to inform the recipient of the requested communication. According to one embodiment and as introduced above, the body of this message can include a number of options for handling and/or redirecting the communication. When the user of the devices acknowledges the request by selecting one of the options, the end device can generate and send a “InitiateCommunication” response back to the server or manager which in turn can connect the initiating device with this recipient device for further communication. Alternatively, and perhaps depending upon the option selected, the recipient device may generate and send a new “InitiateCommunication” request. For example, if the recipient selects on option to redirect a call to video conferencing, a new “InitiateCommunication” request can be generated by the recipient device to be sent back to the initiating device. In turn, when the recipient device receives this message, a notification including the option to initiate a video conference can be presented to the user of the initiating device. If selected, a response can be sent back to the recipient device and a video conference can be initiated between the originator and the recipient by appropriate manager.

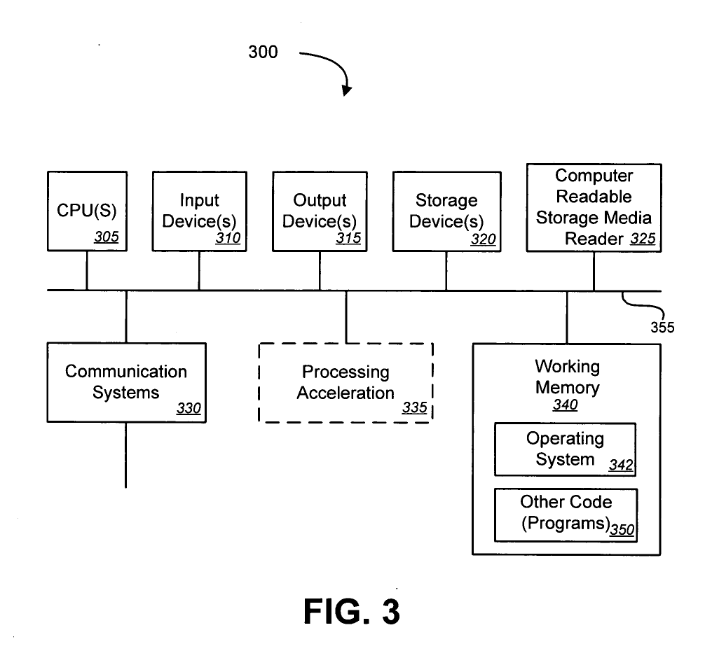

FIG. 3 is a block diagram illustrating an exemplary computer system in which embodiments of the present invention may be implemented. This example illustrates a computer system 300 such as may be used, in whole, in part, or with various modifications, to provide various components of the systems discussed above.

The computer system 300 is shown comprising hardware elements that may be electrically coupled via a bus 355. The hardware elements may include one or more central processing units (CPUs) 305, one or more input devices 310 (e.g., a mouse, a keyboard, etc.), and one or more output devices 315 (e.g., a display device, a printer, etc.). The computer system 300 may also include one or more storage device 320. By way of example, storage device(s) 320 may be disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 325, a communications system 330 (e.g., a modem, a network card (wireless or wired), an infra-red communication device, etc.), and working memory 340, which may include RAM and ROM devices as described above. In some embodiments, the computer system 300 may also include a processing acceleration unit 335, which can include a DSP, a special-purpose processor and/or the like.

The computer-readable storage media reader 325 can further be connected to a computer-readable storage medium, together (and, optionally, in combination with storage device(s) 320) comprehensively representing remote, local, fixed, and/or removable storage devices plus storage media for temporarily and/or more permanently containing computer-readable information. The communications system 330 may permit data to be exchanged with the network 320 and/or any other computer described above with respect to the system 300.

The computer system 300 may also comprise software elements, shown as being currently located within a working memory 340, including an operating system 445 and/or other code 350. It should be appreciated that alternate embodiments of a computer system 300 may have numerous variations from that described above. For example, customized hardware might also be used and/or particular elements might be implemented in hardware, software (including portable software, such as applets), or both. Further, connection to other computing devices such as network input/output devices may be employed.

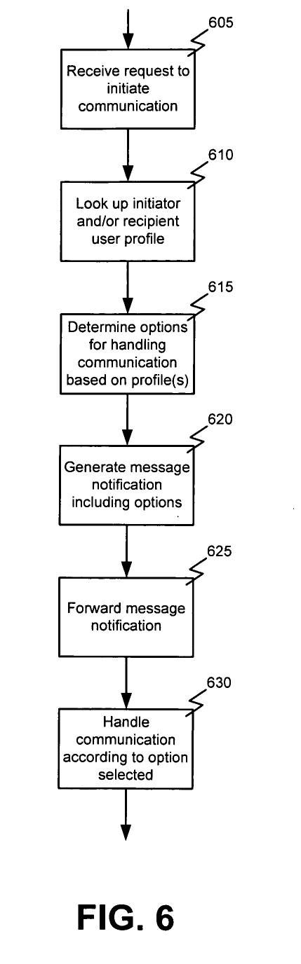

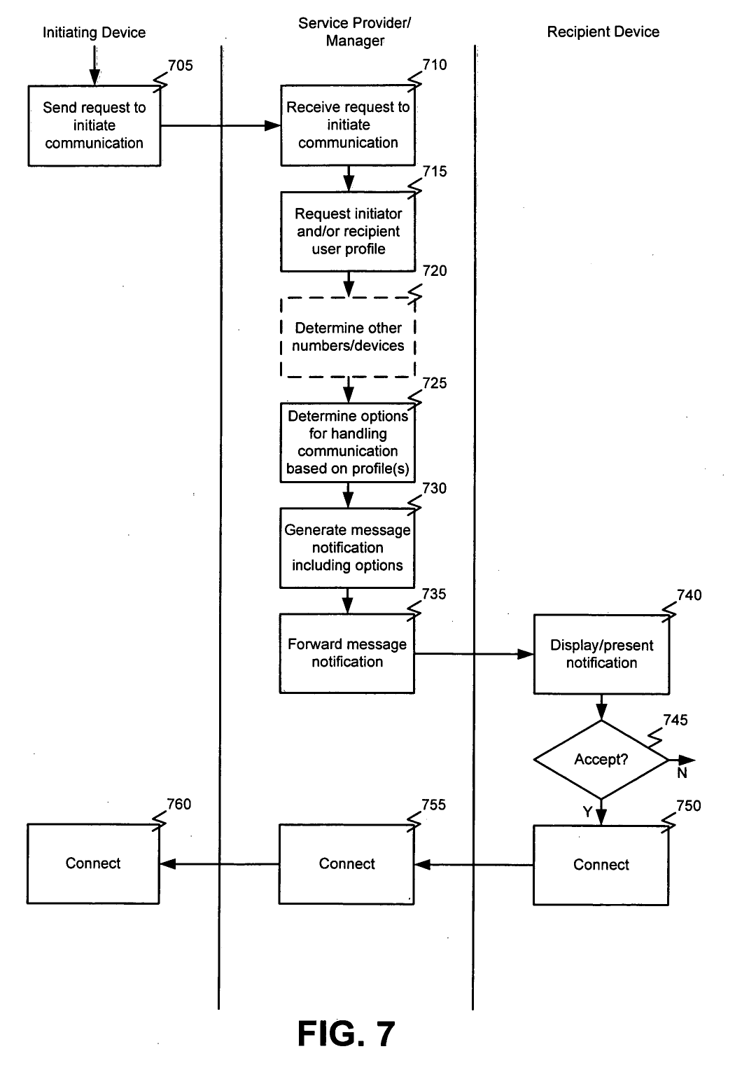

Software of computer system 300 may include code 350 for implementing any or all of the function of the various elements of the architectures as described herein. For example, software, stored on and/or executed by a computer system such as system 300, can provide the functions of the service provider system, a manager, an end device, etc. Methods implemented by software on some of these components will be discussed in detail below with reference to FIGS. 6 and 7.

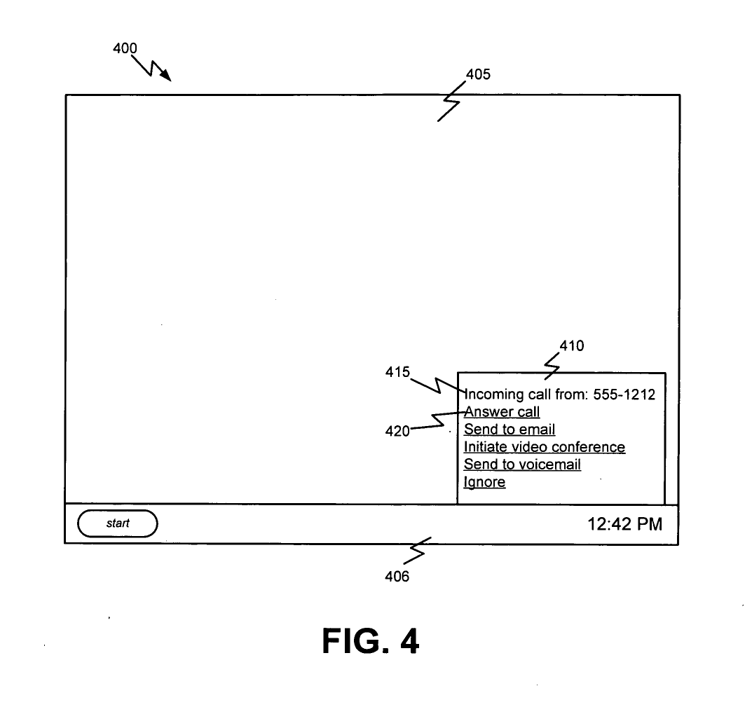

FIG. 4 illustrates an exemplary user interface for informing a user of a communication and presenting options for handling the communication according to one embodiment of the present invention. In this example, a user interface 400 is shown such as may be displayed by a web browser, other personal computer application, or similar display. The interface includes a typical display area 405 and a task bar 410 as is common in many operating systems. According to one embodiment of the present invention, when a notification is received that a communication is pending, such as receiving a phone call or other communication, a notification can be displayed on the interface 400. In this example, the notification is in the form of a pop-up 410 displayed in the display area 405 of the interface above the taskbar 410. In other cases, the notification can take other forms. For example, the notification may be presented as a ticker, a new application window, an icon on the display area 405 or taskbar 406, or any other type of audio and/or visual indication to the user.

Regardless of exactly how the notification is displayed, it can, according to one embodiment of the present invention, include an indication 415 that a communication is being received. In this example, the indication 415 is in the form of a line of text in the pop-up 410 indicating “Incoming call” and a number for the originator of the communication. In other cases, the indication may indicate another type of communication and/or include a name, photograph, etc. of the originator, and/or other information. Additionally, a list of options 420 for handling the communication can be included in the pop-up 410 or other notification. In this example, the list includes a number of hyperlinks that can be clicked by the user to select an option indicated by the text of the link. For example, the link indicating “Answer call” can be clicked by the user to accept the communication. As indicated above, the options presented in this list of options for handling the communication can be based on the user profile information for the originator of the communication, the recipient of the communication, or some combination thereof. For example, if the user profile information of the user does not indicate that he has video conferencing equipment available, the video conferencing option probably would not be included in the list of options.

It should be understood that the format, appearance, content, etc. of the user interface can vary widely without departing from the scope of the present invention. For example, the interface can and likely would vary depending upon the device upon which it is presented. For example, a PC interface will look different from the interface presented by a cell phone, TV, PDA, pager, etc. Furthermore, the way in which notification is given and options presented can vary significantly without departing from the scope of the present invention. For example, rather than a list of links as shown in FIG. 4, options may be presented as clickable buttons or icons, a series of verbal instructions such as “To answer the call press F1”, or any other type of audio, visual, tactile or other sensory indication.

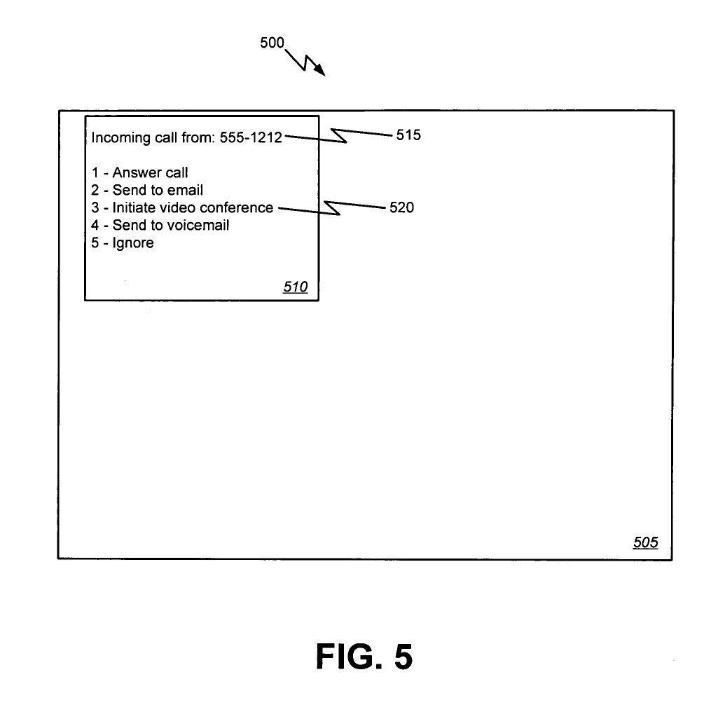

FIG. 5 illustrates an exemplary user interface for informing a user of a communication and presenting options for handling the communication according to an alternative embodiment of the present invention. In this example, a user interface 500 is shown that includes a display 505 such as may be found on a variety of different devices such as an TV, cell phone, etc. The display 505 includes a box 510 for displaying a notification displayed in the display area 505 of the interface. For example, this can represent a pop-up or drop down message box displayed on a television picture or a screen on a cell phone.

As with the previous example, the notification can, according to one embodiment of the present invention, include an indication 515 that a communication is being received. In this example, the indication 515 is in the form of a line of text indicating “Incoming call” and a number for the originator of the communication. In other cases, the indication may indicate another type of communication and/or include a name, photograph, etc. of the originator, and/or other information. Additionally, a list of options 520 for handling the communication can be included in the displayed notification. In this example, the list 520 includes a number of options that can be selected by the user pressing the corresponding number on a remote control, keyboard, or keypad. For example, the option indicating “Ignore” can be selected by the user pressing the number 5 on an input device.

The exact manner in which the user selects an option as well as the format and/or content of the notification can vary depending upon the type of device on which the notification is displayed and/or the type of input device used. For example, if displayed on a cell phone display or television screen, an option can be selected through the keypad of the phone or remote control of the television by pressing the corresponding number. In other cases, the keypad may provide some cursor controls, such as arrow keys, to allow the user to navigate through the options. In such a case, the notification can have a different format suitable for use with that device.

As indicated above, the options presented in this list of options for handling the communication, as well as the format, can be based on the user profile information for, among other things, the recipient of the communication. For example, if the user profile information of the user indicates that the recipient device is a PC, a notification such as described above with reference to FIG. 4 can be generated and sent. In another case, if the user profile database indicates that the recipient device is a television Set-Top Box of a particular type, a notification appropriate for that type of device can be generated and sent.

FIG. 6 is a flowchart illustrating a process for cross-platform redirection of communications according to one embodiment of the present invention. This example represents a process that may be performed by the service provider system discussed above with reference to FIG. 1, one or more of the servers or managers of the management or network element layers discussed above with reference to FIG. 2, or another system or device depending upon the environment in which the methods are implemented.

In this example, the implementing system can receive 605 a request to initiate a communication from an initiating end device. The request can identify an intended recipient device. Receiving a request to initiate a communication can comprises receiving a phone call to a single phone number, receiving a message to a single address such as an email message or an Instant Message (IM), etc. Based on this request, the system can lookup or read 610 user profile information for the initiator and/or the recipient.

A plurality of options for handling the communication by the recipient device can then be determined 615. The options can be based on user profile information from a user of the recipient device, user profile information from a user of the initiating device, a set of default options, and/or other information. According to one embodiment of the present invention, the user profile information from the user of the recipient device comprises one or more predetermined options defined by the user of the recipient device. That is, the options can include one or more customized options set by the user of the recipient device.

According to another embodiment of the present invention, determining 615 a plurality of options for handling the communication by the recipient device can additionally or alternatively comprise determining at least one of the plurality options based information in the user profile database identifying types of devices available to the user of the recipient device. According to yet another embodiment, determining 615 a plurality of options for handling the communication by the recipient device can additionally or alternatively comprise determining at least one of the plurality options based information in the user profile database identifying types of devices available to a user of the initiating device.

Once the options have been determined 615, a notification can be generated 620 to inform the user of the recipient device of the communication. The notification can include an indication of the plurality of options for handling the communication. According to one embodiment of the present invention, such a notification can comprise a “InitiateCommunication” or other common language message such as discussed above. In such a case, the message may include a body containing text or other format information comprising the options to be presented to the user of the recipient device. In other cases, rather than the content of the options, the message may contain other information such as pointers, links, message identifiers, etc. indicating options to be presented.

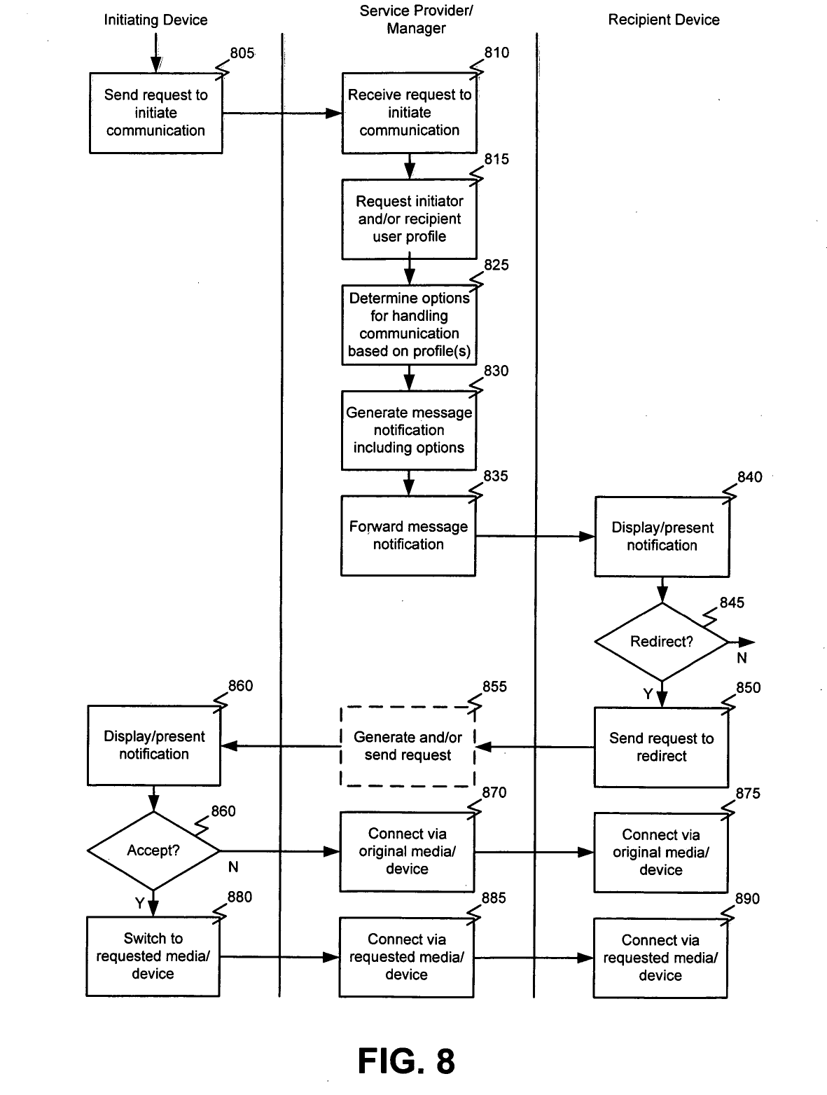

Regardless of the exact format, the notification can be sent 625 to the recipient device. As will be discussed below, the recipient device can display or otherwise use the notification to inform the user of the recipient device of the communication. In response to the user of the recipient device selecting, or not selecting, one of the options, the communication can be handled 630 accordingly. That is, the initiating device and recipient device can be connected or disconnected, the communication can be redirected to another device, the communication can be ignored and allowed to expire, time, out, etc, or other possibilities depending upon the option selected. Two possible scenarios for handling the communication will be discussed below with reference to FIGS. 7 and 8.

FIG. 7 is a flowchart illustrating additional details of a process for cross-platform redirection of communications according to another embodiment of the present invention. This example represents a process that may be performed by the service provider system discussed above with reference to FIG. 1, one or more of the servers or managers of the network element layer discussed above with reference to FIG. 2, or another system or device depending upon the environment in which the methods are implemented and illustrates the processes performed by the initiating device as well as the recipient device.

In this example, the initiating device sends 705 a request to initiate a communication to the service provider system or server as described above. The implementing system, such as a service provider system, can receive 710 a request to initiate a communication from an initiating end device. The request can identify an intended recipient device. Receiving a request to initiate a communication can comprises receiving a phone call to a single phone number, receiving a message to a single address such as an email message or an Instant Message (IM), etc. Based on this request, the system can lookup or read 715 user profile information for the initiator and/or the recipient.

Optionally, a plurality of possible recipient devices for the notification can be determined 720. According to one embodiment, this determination can be based on user profile information from a user of the initiating end device or from the user of the recipient device. Determining 720 a plurality of possible recipient devices can comprise determining an identifier for each of the plurality of possible recipient devices stored in the user profile information from the user of the initiating end device or the recipient device and associated with the intended recipient device. The identifier can comprise a phone number, an email address, an Internet Protocol (IP) address, etc. According to one embodiment of the present invention, the plurality of possible recipient end devices can include the intended recipient device.

A plurality of options for handling the communication by the recipient device can then be determined 725. The options can be based on user profile information from a user of the recipient device, user profile information from a user of the initiating device, a set of default options, and/or other information. According to one embodiment of the present invention, the user profile information from the user of the recipient device comprises one or more predetermined options defined by the user of the recipient device. That is, the options can include one or more customized options set by the user of the recipient device.

According to another embodiment of the present invention, determining 725 a plurality of options for handling the communication by the recipient device can additionally or alternatively comprise determining at least one of the plurality options based information in the user profile database identifying types of devices available to the user of the recipient device. According to yet another embodiment, determining 725 a plurality of options for handling the communication by the recipient device can additionally or alternatively comprise determining at least one of the plurality options based information in the user profile database identifying types of devices available to a user of the initiating device.

Once the options have been determined 725, a notification can be generated 730 to inform the user of the recipient device of the communication. The notification can include an indication of the plurality of options for handling the communication. According to one embodiment of the present invention, such a notification can comprise a “InitiateCommunication” or other common language message such as discussed above. In such a case, the message may include a body containing text or other format information comprising the options to be presented to the user of the recipient device. In other cases, rather than the content of the options, the message may contain other information such as pointers, links, message identifiers, etc. indicating options to be presented.

Regardless of the exact format, the notification can be sent 735 to the recipient device. The recipient device can display 740 or otherwise use the notification to inform the user of the recipient device of the communication. In response to the user of the recipient device selecting an option to accept 745 the communication, the initiating device can be connected 750-760 with the recipient device. That is, in response to the user selecting an option such as “Answer” or some similar option, the initiating device and recipient device can be connected for further communication. Alternatively, if 745 such an option is not selected, the devices may be disconnected, the communication can be ignored and allowed to timeout or expire, or the communication can be redirected as will now be discussed with reference to FIG. 8.

FIG. 8 is a flowchart illustrating details of a process for cross-platform redirection of communications according to yet another embodiment of the present invention. This example represents a process that may be performed by the service provider system discussed above with reference to FIG. 1, one or more of the servers or managers of the network element layer discussed above with reference to FIG. 2, or another system or device depending upon the environment in which the methods are implemented and illustrates the processes performed by the initiating device as well as the recipient device.

In this example, the initiating device sends 805 a request to initiate a communication to the service provider system or server as described above. The implementing system, such as a service provider system, can receive 810 a request to initiate a communication from an initiating end device. The request can identify an intended recipient device. Receiving a request to initiate a communication can comprises receiving a phone call to a single phone number, receiving a message to a single address such as an email message or an Instant Message (IM), etc. Based on this request, the system can lookup or read 815 user profile information for the initiator and/or the recipient.

A plurality of options for handling the communication by the recipient device can then be determined 825. The options can be based on user profile information from a user of the recipient device, user profile information from a user of the initiating device, a set of default options, and/or other information. According to one embodiment of the present invention, the user profile information from the user of the recipient device comprises one or more predetermined options defined by the user of the recipient device. That is, the options can include one or more customized options set by the user of the recipient device.

According to another embodiment of the present invention, determining 825 a plurality of options for handling the communication by the recipient device can additionally or alternatively comprise determining at least one of the plurality options based information in the user profile database identifying types of devices available to the user of the recipient device. According to yet another embodiment, determining 825 a plurality of options for handling the communication by the recipient device can additionally or alternatively comprise determining at least one of the plurality options based information in the user profile database identifying types of devices available to a user of the initiating device.

Once the options have been determined 825, a notification can be generated 830 to inform the user of the recipient device of the communication. The notification can include an indication of the plurality of options for handling the communication. According to one embodiment of the present invention, such a notification can comprise a “InitiateCommunication” or other common language message such as discussed above. In such a case, the message may include a body containing text or other format information comprising the options to be presented to the user of the recipient device. In other cases, rather than the content of the options, the message may contain other information such as pointers, links, message identifiers, etc. indicating options to be presented.

Regardless of the exact format, the notification can be sent 835 to the recipient device. The recipient device can display 840 or otherwise use the notification to inform the user of the recipient device of the communication. If 845 the user of the recipient device selects an option to redirect the communication, the recipient device can send 850 a request back to the implementing system that optionally generates 855 a redirection notification to inform a user of the initiating device of the redirection. Generation 855 of the notification by the implementing system is considered optional since the recipient device may, as part of sending 850 the request generate a redirection notification to be sent directly to the initiating system. Regardless of where it is generated, the redirection notification can include an indication of options for redirecting the communication. That is, similar to the original notification, the redirection notification can include an indication of the plurality of options for handling the communication. According to one embodiment of the present invention, such a redirection notification can comprise a “InitiateCommunication” or other common language message such as discussed above. In such a case, the message may include a body containing text or other format information comprising the options to be presented to the user of the initiating device such as the device and/or media to be redirected to. In this way, the user of the initiating device can be informed that the user of the recipient device wants to redirect the communication.

Therefore, once the redirection notification is received by the initiating device, the redirection notification can be displayed 860 to the user of the initiating device. If 865 the user of the initiating device rejects the redirection, the initiating device can be connected with the recipient device 870-875. If 865 the user of the initiating device accepts the redirection, the user of the initiating device can switch 880 to the requested media or device and/or can be connected 885-890 with the device indicated in the redirection notification.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of providing cross-platform redirection of communications, the method comprising:
receiving a request to initiate a communication from an initiating end device, the request identifying an intended recipient device;
determining a plurality of options for handling the communication by the recipient device, the options based on user profile information from a user of the recipient device;
generating a notification to inform the user of the recipient device of the communication, the notification including an indication of the plurality of options for handling the communication; and
sending the notification to the recipient device.

2. The method of claim 1, further comprising determining a plurality of possible recipient devices for the notification based on user profile information from the user of the recipient device.

3. The method of claim 2 wherein sending the notification to the recipient device further comprises sending the notification to each of the plurality of possible recipient devices.

4. The method of claim 1, wherein receiving a request to initiate a communication comprises receiving a phone call to a single phone number.

5. The method of claim 1, wherein determining a plurality of options for handling the communication is further based on user profile information from a user of the initiating device.

6. The method of claim 1, wherein determining a plurality of options for handling the communication is further based on a set of default options.

7. The method of claim 1, wherein the user profile information from the user of the recipient device comprises one or more predetermined options defined by the user of the recipient device.

8. The method of claim 1, wherein determining a plurality of options for handling the communication by the recipient device comprises determining at least one of the plurality options based on information in the user profile database identifying types of devices available to the user of the recipient device.

9. The method of claim 8, wherein determining a plurality of options for handling the communication by the recipient device further comprises determining at least one of the plurality options based on information in the user profile database identifying types of devices available to a user of the initiating device.

10. The method of claim 1, further comprising in response to the user of the recipient device selecting an option from the plurality of options to accept the communication, connecting the initiating device with the recipient device.

11. The method of claim 1, further comprising in response to the user of the recipient device selecting an option from the plurality of options to redirect the communication, connecting the initiating device with a device selected by the user of the recipient device.

12. The method of claim 1, further comprising in response to the user of the recipient device selecting an option from the plurality of options to redirect the communication:
generating a redirection notification to inform a user of the initiating device of the redirection, the notification including an indication of options for redirecting the communication;
sending the redirection notification to the initiating device;
in response to the user of the initiating device accepting the redirection, connecting the initiating device with a device indicated in the redirection notification; and
in response to the user of the initiating device rejecting the redirection, connecting the initiating device with the recipient device.

13. A system for providing cross-platform redirection of communications, the system comprising:
a communications bus;
a user profile database communicatively coupled with the communications bus and adapted to maintain user profile information for a plurality of users;
a plurality of end devices of different types, each end device communicatively coupled with the communications bus and adapted to send and receive common language messages via the communications bus, to translate common language messages received from the communications bus to a format specific to the end device based on the type, and to store user profile information in the user profile database; and
one or more managers, each manager communicatively coupled with the communications bus, wherein each manager is adapted to receive via the communications bus a request to initiate a communication from an initiating device from the plurality of end devices, the request identifying an intended recipient device from the plurality of end devices, determine a plurality of options for handling the communication by the recipient device, the options based on user profile information from a user of the recipient device and user profile information from a user of the initiating device, generate a notification to inform the user of the recipient device of the communication, the notification including an indication of the plurality of options for handling the communication, and send the notification to the recipient device via the bus.

14. The system of claim 13, wherein determining a plurality of options for handling the communication is further based on a set of default options.

15. The system of claim 13, wherein the user profile information from the user of the recipient device comprises one or more predetermined options defined by the user of the recipient device.

16. The system of claim 13, wherein determining a plurality of options for handling the communication by the recipient device comprises determining at least one of the plurality options based on information in the user profile database identifying types of devices available to the user of the recipient device.

17. The system of claim 16, wherein determining a plurality of options for handling the communication by the recipient device further comprises determining at least one of the plurality options based on information in the user profile database identifying types of devices available to a user of the initiating device.

18. The system of claim 13, further comprising in response to the user of the recipient device selecting an option from the plurality of options to accept the communication, connecting the initiating device with the recipient device.

19. The system of claim 13, further comprising in response to the user of the recipient device selecting an option from the plurality of options to redirect the communication, connecting the initiating device with a device selected by the user of the recipient device.

20. The system of claim 13, further comprising in response to the user of the recipient device selecting an option from the plurality of options to redirect the communication:
generating a redirection notification to inform a user of the initiating device of the redirection, the notification including an indication of options for redirecting the communication;
sending the redirection notification to the initiating device;
in response to the user of the initiating device accepting the redirection, connecting the initiating device with a device indicated in the redirection notification; and
in response to the user of the initiating device rejecting the redirection, connecting the initiating device with the recipient device.

21. A machine-readable medium having stored thereon a series of instruction for which, when executed by a processor, cause the processor to perform cross-platform redirection of communications by:
receiving a request to initiate a communication from an initiating device, the request identifying an intended recipient device;
determining a plurality of options for handling the communication by the recipient device, the options based on user profile information from a user of the recipient device, user profile information from a user of the initiating device, and a set of default options;
generating a notification to inform the user of the recipient device of the communication, the notification including an indication of the plurality of options for handling the communication; and
sending the notification to the recipient device.

22. The machine-readable medium of claim 21, wherein the user profile information from the user of the recipient device comprises one or more predetermined options defined by the user of the recipient device.

23. The machine-readable medium of claim 21, wherein determining a plurality of options for handling the communication by the recipient device comprises determining at least one of the plurality options based on information in the user profile database identifying types of devices available to the user of the recipient device.

24. The machine-readable medium of claim 23, wherein determining a plurality of options for handling the communication by the recipient device further comprises determining at least one of the plurality options based on information in the user profile database identifying types of devices available to a user of the initiating device.

25. The machine-readable medium of claim 21, further comprising in response to the user of the recipient device selecting an option from the plurality of options to accept the communication, connecting the initiating device with the recipient device.

26. The machine-readable medium of claim 21, further comprising in response to the user of the recipient device selecting an option from the plurality of options to redirect the communication, connecting the initiating device with a device selected by the user of the recipient device.

27. The machine-readable medium of claim 21, further comprising in response to the user of the recipient device selecting an option from the plurality of options to redirect the communication:
generating a redirection notification to inform a user of the initiating device of the redirection, the notification including an indication of options for redirecting the communication;
sending the redirection notification to the initiating device;
in response to the user of the initiating device accepting the redirection, connecting the initiating device with a device indicated in the redirection notification; and
in response to the user of the initiating device rejecting the redirection, connecting the initiating device with the recipient device
